(19) United States
(12) Patent Application Publication
(10) Pub. No.: US 2022/0041000 A1
(43) Pub. Date: Feb. 10, 2022

(54) METHOD FOR TREATING A PLASTIC SURFACE

(71) Applicant: Sport Systems Canada Inc., Almonte (CA)

(72) Inventor: Jon DALE, Nepean (CA)

(21) Appl. No.: 17/390,422

(22) Filed: Jul. 30, 2021

Related U.S. Application Data
(60) Provisional application No. 63/061,963, filed on Aug. 6, 2020.

(51) Int. Cl. B41M 5/00; B41M 7/00; B41M 1/30

(52) U.S. Cl. CPC B41M 5/0011; B41M 1/30; B41M 7/0081

(57) ABSTRACT

A method for treating a plastic surface to facilitate the adhesion of a coating. Specifically, the plastic surface is cleaned to remove surface contaminants. The resulting clean surface is then treated by a surface treatment, to thereby produce a treated surface suitable for receiving a coating. In some embodiments, the plastic surface treatment facilitates the adhesion of ink used in UV inkjet printing on plastic surfaces, including surfaces that are textured or irregularly shaped. In one embodiment of the invention, the plastic surface is a surface of a high density polyethylene (HDPE) plastic seat that is used for telescopic seating.

### RELATED APPLICATIONS

This application claims the benefit of U.S. Provisional Application No. 63/061,963 filed on Aug. 6, 2020.

### TECHNICAL FIELD

The present invention relates to treating a plastic surface. More specifically, the present invention relates to treating a plastic surface to facilitate the adhesion of a coating.

### BACKGROUND

Plastic is ubiquitous in consumer products. Applying a coating to such plastic products is often desirable. For example, coatings can be in the form of printed ink or paint that depicts a graphic. Such a graphic can comprise letters, colours, lines, images, and/or anything else suitable for display in such a coating. However, plastic is often composed of organic compounds with intrinsic properties unfavourable for the adhesion of a coating with the plastic surface. Such properties can lead to premature peeling, degradation, wearing, and other effects that result in a low quality product. Thus, applying coatings to plastic surfaces requires methods and processes that promote better adhesion to the plastic surface to create higher quality products.

In particular, high-density polyethylene (HDPE) is a versatile plastic that has applications in many fields due to its durability and resistance to warping. In addition, the plastic is known to retain its colour well when exposed to various environmental conditions (such as strong light), in comparison to other plastics. For these reasons, HDPE is often used to construct the seats of telescopic seating, which is typically used in sports stadiums or school gymnasiums.

Printed graphics are often desired on telescopic seating to depict, for example, a team mascot or logo. Alternatively, separate graphics, such as small logos, can be printed on each seat. Printing is usually performed in a separate process, after the seat has been manufactured. One common printing method on HDPE is ultraviolet (UV) inkjet printing. This low-cost printing method allows for high quality printing in a wide range of colours, and allows many colours to be simultaneously used in a single printed graphic.

However, the chemical and physical properties that make HDPE an attractive material for telescopic seating also result in poor adhesion qualities for ink. Specifically, the relatively low surface energy of HDPE inhibits ink wetting, and thus limits the ink's ability to adhere to the surface effectively. The result is a seat that is not conducive to UV printing, e.g., a seat printed with poorly distributed or easily removed ink, or a seat that is entirely unreceptive to UV inkjet printing.

The adhesion qualities of ink to the HDPE seat can be further exacerbated by other factors. For instance, antioxidant additives, which are often added to promote demolding during the seat manufacturing process, can also inhibit adhesion. Similarly, seats manufactured with a textured surface or an irregular shape are more difficult to print on than seats with a smooth or flat surface.

These issues are addressed in the prior art in multiple ways. One common printing method is to apply the design to a thin polypropylene film, or other polymer film, that is melted to the seat surface using heat and pressure. However, this process removes most, if not all, texture from the seat. This process can also be time consuming and expensive. Furthermore, this process can only implement a few solid colours in a design, which can limit the artistry in a printed graphic where many colours or shades are desired.

Another solution is to use an alternative seat material with better ink adhesion, such as a different plastic, but this comes at the cost of other qualities such as durability and resistance to warping. This results in higher costs over time as the seats wear down faster and/or damage more easily.

From the above, there is therefore a need to overcome the shortcomings of the prior art by providing a process that facilitates high quality UV inkjet printing and other coating methods on plastic surfaces, including on HDPE, without sacrificing properties of the plastic product such as surface texture or durability.

### SUMMARY

This document discloses a method for treating a plastic surface to facilitate the adhesion of a coating. Specifically, the plastic surface is cleaned to remove surface contaminants. The resulting clean surface is then treated by a surface treatment, to thereby produce a treated surface suitable for receiving a coating. In some embodiments, the plastic surface treatment facilitates the adhesion of ink used in UV inkjet printing on plastic surfaces, including surfaces that are textured or irregularly shaped. In one embodiment of the invention, the plastic surface is a surface of a high density polyethylene (HDPE) plastic seat that is used for telescopic seating.

In a first aspect, the present invention provides a method for treating a plastic surface before applying a coating, the method comprising: removing surface contaminants from the plastic surface, to thereby produce a clean surface; and treating the clean surface with a surface treatment, to thereby produce a treated surface; wherein the treated surface is suitable for receiving the coating.

In a second aspect, the present invention provides a fixture for supporting a plastic object during a printing process, wherein the fixture is designed to receive the plastic object and to be mounted on a printer, such that the printer prints on a surface of the plastic object.

### BRIEF DESCRIPTION OF THE DRAWINGS

The present invention will now be described by reference to the following figures, in which identical reference numerals refer to identical elements and in which:

FIG. 1 is a flow chart detailing a method according to an aspect of the invention;

FIG. 2 shows a fixture designed to hold a plastic seat and cooperate with the printer according to an embodiment of the invention;

FIG. 3 shows a textured HDPE seat with a printed graphic according to an embodiment of the invention; and

FIG. 4 shows telescopic seating comprised of HDPE seats with a printed graphic spanning multiple seats.

### DETAILED DESCRIPTION

This document discloses a method for treating a plastic surface to facilitate the adhesion of a coating. Specifically, the plastic surface is cleaned to remove surface contaminants. The resulting clean surface is then treated by a surface treatment, to thereby produce a treated surface suitable for receiving a coating. In some embodiments, the plastic surface treatment facilitates the adhesion of ink used in UV inkjet printing on plastic surfaces, including surfaces that are textured or irregularly shaped. In one embodiment of the invention, the plastic surface is a surface of a high density polyethylene (HDPE) plastic seat that is used for telescopic seating.

As would be clear, the term “plastic surface” as used herein refers to a surface of a plastic object. The plastic object may be any kind of object having any dimensions, including without limitation, seats, slats, slabs, and flat or curved plastic objects. A person skilled in the art will understand how to adapt the various methods disclosed herein to surfaces of objects of different sizes and shapes.

Additionally, it should be noted that the expression “at least one of X and Y”, as used herein, is intended to mean, and should be construed as meaning, “[X], [Y], or [X] and [Y]”.

In some embodiments, the coating that is applied to the plastic surface displays a graphic. In this document, the term “graphic” is not intended to be limited to pictures or graphical representations. That is, the term “graphic” should be considered to include, without limitation: words; lines; shapes; representational pictures, images, and designs; non-representational pictures, images, and designs; and/or colours. However, as would be understood by a person skilled in the art, the coating is not required to display a visible graphic. As a non-limiting example, in some embodiments, a transparent coating that permits easier cleaning may be applied to the plastic surface. Similarly, coatings that do not comprise a graphic may be applied to reduce wear or damage.

In one embodiment of the invention, the plastic surface comprises high density polyethylene (HDPE). In other embodiments, the plastic surface comprises any one of or a combination of high density polyethylene, low density polyethylene, polyethylene, ultra-high molecular weight polyethylene, polypropylene, polyvinyl chloride, polyethylene terephthalate, polystyrene, polylactide, polycarbonate, polymethyl methacrylate, polyoxymethylene, polyamide, and/or acrylonitrile butadiene styrene.

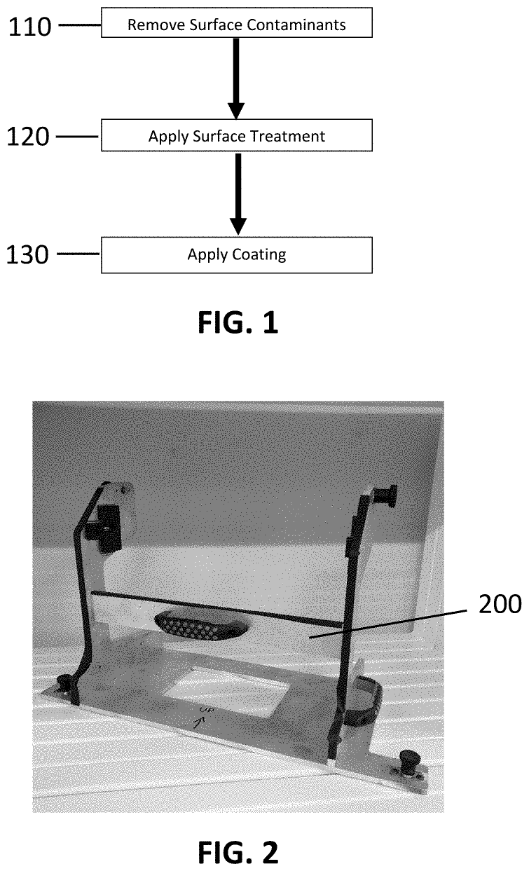

FIG. 1 is a flow chart detailing a plastic surface treatment method according to one aspect of the invention. At step 110, the plastic surface is cleaned to remove surface contaminants from the surface. The surface contamination can be composed of one or many different contaminants. For example, such surface contaminants can be, but are not limited to, dust fibres, oil, and residue. Such residue can include, but is not limited to, residual demolding agents present from the manufacturing process. As would be understood by a person skilled in the art, the surface contaminants on the plastic surface will vary according to the environment(s) and handling to which the plastic surface has been exposed, and thus the examples provided above are not intended to limit the possible composition of surface contaminants on the plastic surface.

Many suitable cleaning techniques can be used. However, in some embodiments, the plastic surface is cleaned by applying an alcohol. In preferred embodiments, the alcohol is 99% isopropyl alcohol. However, alcohols with lower concentrations can be used. Additionally, non-alcohol solvents can be used in some embodiments, provided that the cleaning effects on the plastic surface are similar—that is, provided that surface contaminants have been removed from the resulting clean surface.

In other embodiments, the surface treatment method further comprises a step of sanding the plastic surface. Sanding the plastic surface can remove some or all of the texture on the plastic surface. The flatter plastic surface can promote better adhesion of the coating. A person skilled in the art would understand that either a chemical treatment (e.g., alcohol/solvent application) or a mechanical treatment (e.g., sanding), or a combination of both treatment techniques can be used before step 120 in the method.

At step 120, the plastic surface is treated, to thereby produce a treated surface. In an embodiment, the surface treatment is a plasma treatment. In this document, plasma is understood to be an ionized gas. The ionized gas that makes up a plasma is composed of molecules and/or atoms that have undergone ionization (removal of electrons) and free electrons. A plasma is achieved by increasing the energy of the gas such that electrons are stripped from the molecules or atoms. This ionization can be achieved by applying a sufficiently large electric field or high temperature. Additionally, the energy applied to the system must be sustained in order to maintain the plasma state, otherwise the ionized species will recombine with the electrons to form a neutral gas.

Plasma treatment, sometimes referred to as plasma cleaning, is a technique where plasma is used to treat surfaces to promote adhesion of other materials to the surface. For example, plasma treatment is used on surfaces that are to be glued or bonded together, or on surfaces on which a coating is desired. Such a coating can be, but is not limited to, paint or ink. Plasma treatment can (i) clean the surface, and (ii) activate the surface, both of which increase the surface energy.

Surface energy is a measure of excess energy resulting from disrupted bonds at an object's surface relative to the object's bulk composition. A material will have a higher surface energy if it has more surface exposed (i.e., higher surface area) and/or more higher energy atoms at the surface. As would be understood by a person skilled in the art, a material will minimize its energy as much as possible to become more stable. Thus, higher energy atoms at the surface will attract other molecules or atoms to minimize the surface energy. Therefore, a surface with higher surface energy will have better adhesion properties than a surface with lower surface energy. However, the tendency of high energy atoms to attract other molecules and atoms can result in a layer of surface contamination and/or adsorbed molecules. While some surface contaminants can be removed by traditional cleaning methods, such as those described at step 110 in FIG. 1, surface contaminants at the molecular and atomic scale require more effective treatments, such as a plasma treatment.

Plasma generates UV light, which has enough energy to break down chemical bonds and interactions between molecules and the surface. Additionally, some chemical species used in plasma (e.g., oxygen) can react with organic surface contaminants and reduce them to other compounds, such as water and carbon dioxide, which are typically removed from plasma treatment area by e.g., a vacuum pump. Because plasma is composed of energetic species, it is also possible for the surface to be bombarded by the ionized molecules or atoms, which also removes surface contaminants at the molecular and atomic scale. Thus, plasma treatment further cleans the surface, increases the surface energy, and promotes better adhesion with other materials.

Plasma treatment can also activate the surface, where activation refers to a strong tendency for a chemical species to react with another molecule or atom. This is also known as functionalizing the surface. After the plasma treatment cleans the surface by removing molecular surface contaminants, some reactive species can bond to the surface. Highly reactive species, such as oxygen, will bond to the surface and increase the surface energy. This is particularly useful for low surface energy materials, such as some plastics, where high surface energy is required for the adhesion of other materials, such as inks or paint.

In some embodiments of the invention, the plasma treatment comprises applying to the plastic surface at least one of air plasma, atmospheric plasma, chemical plasma, or flame plasma. The plasma treatment should be applied according to the appropriate procedure for the instrument or device that performs the plasma treatment, and such that the end result is an increase in the plastic surface's surface energy. A person skilled in the art would understand that a surface treatment different from the plasma treatment can be applied to the plastic surface that similarly increases the surface energy to promote adhesion and bonding (e.g., a UV-ozone surface treatment or a flame treatment).

In some embodiments, the first step of the process may include removing debris that is on the plastic surface, for instance, by blowing the plastic surface with compressed air. A person skilled in the art would understand that this debris removal step may be optional. For example, if the seat has come from the manufacturer without any handling before treatment, then this debris removal step can be omitted.

Additionally, in some embodiments, the plastic surface is coated with an adhesion promoter after the surface treatment step 120. For example, RUCO™ 100-VR-1075 Primer can be used as the adhesion promoter. Many different adhesion promoters, as known to a person skilled in the art, can be used. Such adhesion promoters can comprise, without limitation, any of toluene, silane, methyl-benzene, ethyl-benzene, xylene, methanol, acetone, and/or propanone.

Note that the benefits of the treatment process, in preparing the plastic surface to receive a coating, are not necessarily permanent. Thus, as would be understood by a person skilled in the art, any coating is preferably applied relatively soon after treating the surface. In some cases, if too much time has elapsed since the surface was treated, all advantages of the treatment may be lost. In such cases, the treatment will have to be repeated before a coating is applied.

At step 130, a coating is applied to the plastic surface. In some embodiments of the invention, the coating is cured after being applied to the surface. The curing process can use UV light, or any other suitable curing mechanism as known in the art.

In some embodiments, the coating is printed on the plastic surface using an inkjet printer. In some embodiments, the plastic object can be mounted on a fixture that locks into a print bed of the printer. This can be used in cases where the plastic surface cannot be oriented properly in the printer for effective printing.

FIG. 2 shows a fixture designed to hold a plastic seat and lock into the print bed of a UV inkjet printer according to one implementation of the invention. A person skilled in the art would recognize that such a fixture can be customized, for example, to hold more than one plastic object, hold one or more plastic objects of different shapes and/or sizes, or be configured for a different type of coating application method. Such different type of application method can include, but is not limited to, a different printer brand or type. A person skilled in the art would also recognize that some plastic surfaces would not require a customized fixture to enable printing on the plastic surface. Accordingly, the dimensions of the fixture as shown in this figure should not be considered to limit the scope of the fixture provided in this invention.

### EXAMPLE

As an example, a plastic seat was treated and printed according to the methods disclosed herein. As should be understood, this example is provided to illustrate a possible application of the methods of the present invention. However, nothing in this invention should be considered to limit the scope of the invention in any way. The person skilled in the art would understand many possible variations and/or alternatives to the example discussed, all of which should be construed as falling within the scope of the present invention.

The plastic surface used in this example was an HDPE seat for telescopic seating. The surface was blown with compressed air to remove debris or particulate matter on the surface. A lint-free cloth was used to apply 99% isopropyl alcohol to the surface. A flame plasma treatment was applied such that the flame contacts the surface for approximately half a second. While the best results were obtained when the flame, in a single pass, was in contact with the surface for approximately half a second, there are limits as to how long this step should last. The flame should not contact the plastic surface for more than approximately two (2) seconds, as this will begin melting the surface of the seat due to the flame's high temperature and will render the seat defective. An adhesion promoter was applied to the surface just prior to printing. In this case, the adhesion promoter used was RUCO™ 100-VR-1075 Primer.

The entire treatment was completed no more than two (2) hours before printing. In this implementation, with these materials and parameters, the benefits of the treatment would be lost approximately twenty-four (24) hours after treatment, after which the treatment method should be repeated. The seat was attached to a custom fixture that locks into the print bed of a UV-inkjet printer. Ink was then printed on to the seat and cured using UV light.

As would be understood by a person skilled in the art, the exact time for which the benefits of the treatment will last will vary according to various factors. Such factors can include, but are not limited to, the treatment parameters and migration of molding agent in the plastic object to the plastic surface.

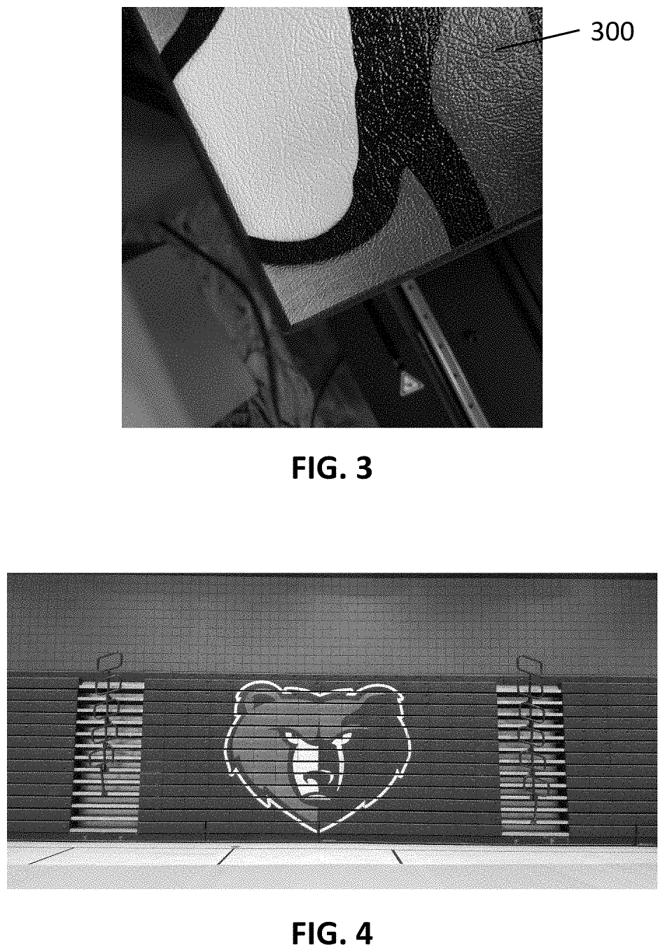

FIG. 3 shows the textured HDPE seat with a printed graphic coating, applied as detailed above. The treatment process described according to FIG. 1 can facilitate effective UV inkjet printing on an irregular surface, such as HDPE, without compromising the quality of the printed graphic, the material choice for the plastic seat, or the shape and texture of the plastic seat.

FIG. 4 shows telescopic seating comprised of HDPE seats with printed graphic coatings, applied according to the methods disclosed herein. As can be seen, the coatings applied to these seats represent a single printed graphic that spans multiple seats. A person skilled in the art would understand that a printed graphic could span one seat or multiple seats, as desired.

Again, nothing in this example is intended to be limiting in any way. This example merely suggests one potential process that a person skilled in the art may use, according to the embodiments of the invention described herein.

A person understanding this invention may now conceive of alternative structures and embodiments or variations of the above, all of which are intended to fall within the scope of the invention as defined in the claims that follow.

We claim:

1. A method for treating a plastic surface before applying a coating, the method comprising:
removing surface contaminants from the plastic surface, to thereby produce a clean surface; and
treating the clean surface with a surface treatment, to thereby produce a treated surface;
wherein the treated surface is suitable for receiving the coating.

2. The method according to claim 1, wherein a printer is used to apply the coating.

3. The method according to claim 1, further comprising the step of curing the coating after the coating is applied to the plastic surface.

4. The method according to claim 3, wherein the coating is cured using ultraviolet light.

5. The method according to claim 2, wherein the plastic surface is a surface of a plastic object, and wherein the plastic object is mounted on a fixture after the surface treatment and before applying the coating, wherein the fixture is designed to cooperatively receive the plastic object and to be mounted on the printer, and wherein the fixture supports the plastic object during a printing process.

6. The method according to claim 5, wherein the fixture is designed to be mounted on a print bed of the printer.

7. The method according to claim 1, wherein the coating comprises at least one of ink and paint.

8. The method according to claim 1, wherein the plastic surface comprises at least one of: high density polyethylene, low density polyethylene, polyethylene, ultra-high molecular weight polyethylene, polypropylene, polyvinyl chloride, polyethylene terephthalate, polystyrene, polylactide, polycarbonate, polymethyl methacrylate, polyoxymethylene, polyamide, and acrylonitrile butadiene styrene.

9. The method according to claim 1, wherein the step of removing surface contaminants from the plastic surface comprises applying an alcohol to the plastic surface.

10. The method according to claim 9, wherein the alcohol is 99% isopropyl alcohol.

11. The method according to claim 1, wherein the method further comprises sanding the plastic surface before the step of treating the plastic surface with the surface treatment.

12. The method according to claim 1, wherein the surface treatment is a plasma treatment that comprises applying at least one of: air plasma, atmospheric plasma, chemical plasma, and flame plasma to the clean surface.

13. The method according to claim 1, further comprising a debris removal step before the step of removing the surface contaminants from the plastic surface, wherein compressed air is used to remove debris from the plastic surface.

14. The method according to claim 1, wherein the method further comprises applying an adhesion promoter to the treated surface before applying the coating to the plastic surface.

15. The method according to claim 14, wherein the adhesion promoter comprises at least one of:
toluene, silane, methyl-benzene, ethyl-benzene, xylene, methanol, acetone, and propanone.

16. A fixture for supporting a plastic object during a printing process, wherein the fixture is designed to receive the plastic object and to be mounted on a printer, such that the printer prints on a surface of the plastic object.
